(19) United States
(12) Patent Application Publication
(10) Pub. No.: US 2019/0323637 A1
(43) Pub. Date: Oct. 24, 2019

(54) ELECTRICAL CONDUIT COUPLER

(71) Applicant: Hubbell Incorporated, Shelton, CT (US)

(72) Inventors: Kenneth M. Kiely, Oxford, CT (US); Steven James Johnson, Buchanan, MI (US)

(21) Appl. No.: 16/390,108

(22) Filed: Apr. 22, 2019

Related U.S. Application Data
(60) Provisional application No. 62/762,155, filed on Apr. 23, 2018.

(51) Int. Cl. F16L 15/00; F16L 15/08

(52) U.S. Cl. CPC F16L 15/007; F16L 15/08

(57) ABSTRACT

The present disclosure provides couplers used to connect one length of rigid electrical conduit to another length of rigid electrical conduit. The couplers include a body having a first coupling portion, a second coupling portion, a stop portion positioned between the first coupling portion and the second coupling portion, and a longitudinal bore extending from the first coupling portion through the stop portion to the second coupling portion. The longitudinal bore within the first coupling portion is a threaded bore capable of receiving a threaded end of a first threaded electrical conduit. The longitudinal bore within the second coupling portion has a diameter capable of receiving a threaded end of a second threaded conduit or an unthreaded end of an unthreaded conduit. The longitudinal bore within the stop portion has a diameter that provides a wire passage between the first threaded conduit and the second threaded conduit or the unthreaded conduit.

### CROSS REFERENCE TO RELATED APPLICATIONS

The present application is based on and claims benefit from co-pending U.S. Provisional Patent Application Ser. No. 62/762,155 filed on Apr. 23, 2018 entitled “Electrical Conduit Coupler and Method” the contents of which are incorporated herein in their entirety by reference.

### BACKGROUND

### Field

The present disclosure generally relates to electrical conduit couplers used to connect one length of electrical conduit to another length of electrical conduit. More specifically, the present disclosure relates to electrical conduit couplers used to connect one length of rigid electrical conduit to another length of rigid electrical conduit.

Electrical conduit couplers join lengths, e.g., ten-foot lengths, of electrical conduit and provide a smooth interior transition for insulated electrical wires or conductors from one electrical conduit to another electrical conduit in compliance with product listing agencies, such as Underwriters Laboratories (UL), and in accordance with the National Electrical Code (NEC). Some convention electrical conduit couplers used to couple one length of rigid electrical conduit with threaded ends to another length of rigid electrical conduit with threaded ends utilize multiple pieces that form each electrical conduit coupler. To install such multi-piece electrical conduit couplers, an electrician first disassembles the multi-piece electrical conduit coupler. With the multi-piece electrical conduit coupler disassembled, the electrician slides a body component of the electrical conduit coupler over a threaded end of a first length of rigid electrical conduit. The electrician tightens an internal bushing, i.e., a second component of the multi-piece of the electrical coupler, onto threaded end of the first length of rigid electrical conduit. The electrician tightens a nut, i.e., a third component of the multi-piece of the electrical coupler, onto a threaded end of a second threaded rigid conduit, and then tightens the body component to the nut component to complete the multi-piece electrical conduit couplers and couple the first rigid electrical conduit to the second rigid electrical conduit. The installation process increases the labor costs for installing such electrical conduit couplers, and increases the material expenses associated with the cost to purchase such electrical conduit couplers. Further, such electrical conduit couplers are not suitable for use with unthreaded rigid conduits.

Another conventional electrical conduit coupler used to couple one length of rigid electrical conduit with threaded ends to another length of rigid electrical conduit with threaded ends does not align the threaded ends of the rigid electrical conduits within the electrical coupler when installed. Misaligned threaded ends of the rigid electrical conduits within the electrical coupler may result in damage to the insulation jacket surrounding the electrical wires when the electrical wires are pulled through the rigid electrical conduit.

Another conventional electrical conduit coupler used to couple one length of rigid electrical conduit to another length of rigid electrical conduit utilizes set-screws to secure the electrical conduit coupler to the rigid electrical conduit. Such set-screw type electrical conduit couplers are only capable of connecting unthreaded rigid electrical conduits.

### SUMMARY

The present disclosure provides embodiments of couplers used to connect one length of electrical conduit to another length of electrical conduit. For example, the couplers according to the present disclosure can be used to connect one length of threaded rigid electrical conduit to another length of threaded rigid electrical conduit, or the couplers according to the present disclosure can be used to connect one length of unthreaded rigid electrical conduit to a length of threaded rigid electrical conduit.

In one exemplary embodiment, the electrical conduit coupler includes a body having a first coupling portion, a second coupling portion, a stop portion positioned between the first coupling portion and the second coupling portion, and a longitudinal bore extending from the first coupling portion through the stop portion to the second coupling portion. The longitudinal bore within the first coupling portion is preferably a threaded bore capable of receiving a threaded end of a first threaded electrical conduit. The longitudinal bore within the second coupling portion preferably has a diameter capable of receiving a threaded end of a second threaded conduit and/or an unthreaded end of an unthreaded conduit. The longitudinal bore within the stop portion preferably has a diameter that provides a wire passage between the first threaded conduit and the second threaded conduit or the unthreaded conduit. In some embodiments, the second coupling portion of the body includes at least one aperture, and at least one fastener within the at least one aperture that is used to releasably secure the second threaded conduit or the unthreaded conduit to the body. In other embodiments, the second coupling portion of the body includes a plurality of spaced apart apertures and a plurality of fasteners where one of the plurality of fasteners is within one of the plurality of apertures, and where the plurality of fasteners are used to releasably secure the second threaded conduit or the unthreaded conduit within the longitudinal bore of the second coupling portion of the body. The length of the second coupling portion is preferably greater than or equal to a length of the first coupling portion. In this exemplary embodiment, the first coupling portion is a female coupling portion and the second coupling portion is also a female coupling portion.

In another exemplary embodiment, the electrical conduit coupler includes a body having a first coupling portion, a second coupling portion, a stop portion positioned between the first coupling portion and the second coupling portion, and a longitudinal bore extending from the first coupling portion through the stop portion to the second coupling portion. In this exemplary embodiment, the length of the second coupling portion is at least twice the length of the first coupling portion. The longitudinal bore within the first coupling portion is a threaded bore capable of receiving a threaded end of a first threaded electrical conduit. The longitudinal bore within the second coupling portion preferably has a diameter capable of receiving a threaded end of a second threaded conduit or an unthreaded end of an unthreaded conduit. The longitudinal bore within the stop portion has a diameter that provides a wire passage between the first threaded conduit and the second threaded conduit or the unthreaded conduit. The second coupling portion of the body includes at least one stop mounting aperture and at least one stop member within the stop mounting aperture, the at least one stop member being movable within the stop mounting aperture between an engaging position and a non-engaging position. The second coupling portion of the body also includes at least one aperture, and at least one fastener within the at least one aperture and used to releasably secure the second threaded conduit or the unthreaded conduit to the body. In this exemplary embodiment, the first coupling portion is a female coupling portion and the second coupling portion is also female coupling portion.

In another exemplary embodiment, the electrical conduit coupler includes a body having a male coupling portion, a female coupling portion, a stop portion positioned between the male coupling portion and the female coupling portion, and a longitudinal bore extending from the male coupling portion through the stop portion to the female coupling portion. In this exemplary embodiment, the longitudinal bore within the male coupling portion is a smooth bore. The longitudinal bore within the female coupling portion has a smooth bore having a diameter capable of receiving a threaded end of a second threaded conduit or an unthreaded end of an unthreaded conduit. The longitudinal bore within the stop portion has a smooth bore with a diameter that provides a wire passage between the first threaded conduit and the second threaded conduit or the unthreaded conduit. The male coupling portion may be a threaded nipple. In some instances, the female coupling portion of the body includes at least one aperture, and at least one fastener within the at least one aperture used to releasably secure the second threaded conduit or the unthreaded conduit to the body. In other instances, the female coupling portion of the body includes a plurality of spaced apart apertures and a plurality of fasteners where one of the plurality of fasteners is within one of the plurality of apertures, and where the plurality of fasteners are used to releasably secure the second threaded conduit or the unthreaded conduit within the longitudinal bore of the female coupling portion to the body.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a perspective view of an exemplary embodiment of an electrical conduit coupler according to the present disclosure;

FIG. 2 is a cross-sectional view of the electrical conduit coupler of FIG. 1 taken from line 2-2, and illustrating a female first coupling portion, a female second coupling portion and a stop portion between the first and second coupling portions;

FIG. 3 is an end elevation view of the electrical conduit coupler of FIG. 2 taken from line 3-3, illustrating an end of the second coupling portion of the electrical conduit coupler that can receive a threaded or unthreaded end of an electrical conduit and exemplary positioning of mounting apertures in the second coupling portion;

FIG. 4 is an end elevation view of the electrical conduit coupler of FIG. 2 taken from line 4-4, illustrating an end of the first coupling portion of the conduit coupler that can receive a threaded end of an electrical conduit;

FIG. 5 is the cross-sectional view of the electrical conduit coupler of FIG. 2, and illustrating an electrical conduit with a threaded end inserted into the first coupling portion and an electrical conduit with an unthreaded end inserted into the second coupling portion;

FIG. 6 is a cross-sectional view of the electrical conduit coupler and electrical conduits of FIG. 5 taken from line 6-6, and illustrating an insulated electrical conductor passing through the two electrical conduits and a stop portion of the electrical conduit coupler;

FIG. 7 is a cross-sectional view of the conduit coupler of FIG. 2, and illustrating an electrical conduit with a threaded end within the first coupling portion, and an electrical conduit with an unthreaded end within the second coupling portion, where the electrical conduits are engaging the stop portion of the electrical conduit coupler;

FIG. 8 is a perspective view of another exemplary embodiment of an electrical conduit coupler according to the present disclosure;

FIG. 9 is a side elevation view in cross-section of the conduit coupler of FIG. 8 taken from line 9-9, illustrating a male first coupling portion, a female second coupling portion and a stop portion between the first coupling portion and the second coupling portion;

FIG. 10 is a perspective view of another exemplary embodiment of an electrical conduit coupler according to the present disclosure;

FIG. 11 is a cross-sectional view of the conduit coupler of FIG. 10 taken from line 11-11, illustrating a female first coupling portion, a female second coupling portion, a stop portion between female the first coupling portion and the female second coupling portion, and illustrating a removable positioning stop within the second coupling portion;

FIG. 12 is a cross-sectional view of the conduit coupler of FIG. 11, illustrating a conduit with threaded ends positioned for insertion into a first coupling portion of the conduit coupler and a conduit with unthreaded ends positioned for insertion into a second coupling portion of the conduit coupler, and illustrating the removable second stop member positioned to permit entry of the electrical conduit with unthreaded ends within the second coupling portion;

FIG. 13 is a cross-sectional view of the conduit coupler of FIG. 11, illustrating the removable positioning stop positioned to limit entry of an electrical conduit with unthreaded ends within the second coupling portion; and

FIG. 14 is a cross-sectional view of the conduit coupler of FIG. 11, illustrating the conduit with threaded ends being removed from the conduit coupler.

### DETAILED DESCRIPTION

The present disclosure provides embodiments of electrical conduit couplers used to connect one length of electrical conduit to another length of electrical conduit. For example, the electrical conduit couplers according to the present disclosure can be used to connect one length of rigid electrical conduit with threaded ends to another length of rigid electrical conduit with threaded ends, or the electrical conduit couplers according to the present disclosure can be used to connect a length of rigid electrical conduit with unthreaded ends to a length of rigid electrical conduit with threaded ends. For ease of description, the electrical conduit couplers referred to herein may also be referred to as the “coupler” in the singular and the “couplers” in the plural. For ease of description, the rigid electrical conduits referred to herein may also be referred to as the “conduit” in the singular or “conduits” in the plural. A length of conduit described herein may have threaded ends, or a length of conduit may have unthreaded ends. For ease of description, a length of conduit with threaded ends may also be referred to herein as “threaded conduit” in the singular and “threaded conduits” in the plural. A length of conduit with unthreaded ends, e.g., with smooth ends, may also be referred to herein as “unthreaded conduit” in the singular and “unthreaded conduits” in the plural.

The couplers according to the present disclosure are typically configured to couple conduits of one size with conduits of the same size or a different size. For example, a coupler may be designated as a ¾-inch coupler that would couple ¾-inch conduits. As another example, a coupler may be designated as a 1-inch coupler that would couple 1-inch conduits. The coupler according to the present disclosure may also be a reducer coupler that couples a length of conduit of one size to a length of conduit of another size. For example, a reducer coupler may couple a 1-inch conduit to a ¾-inch conduit.

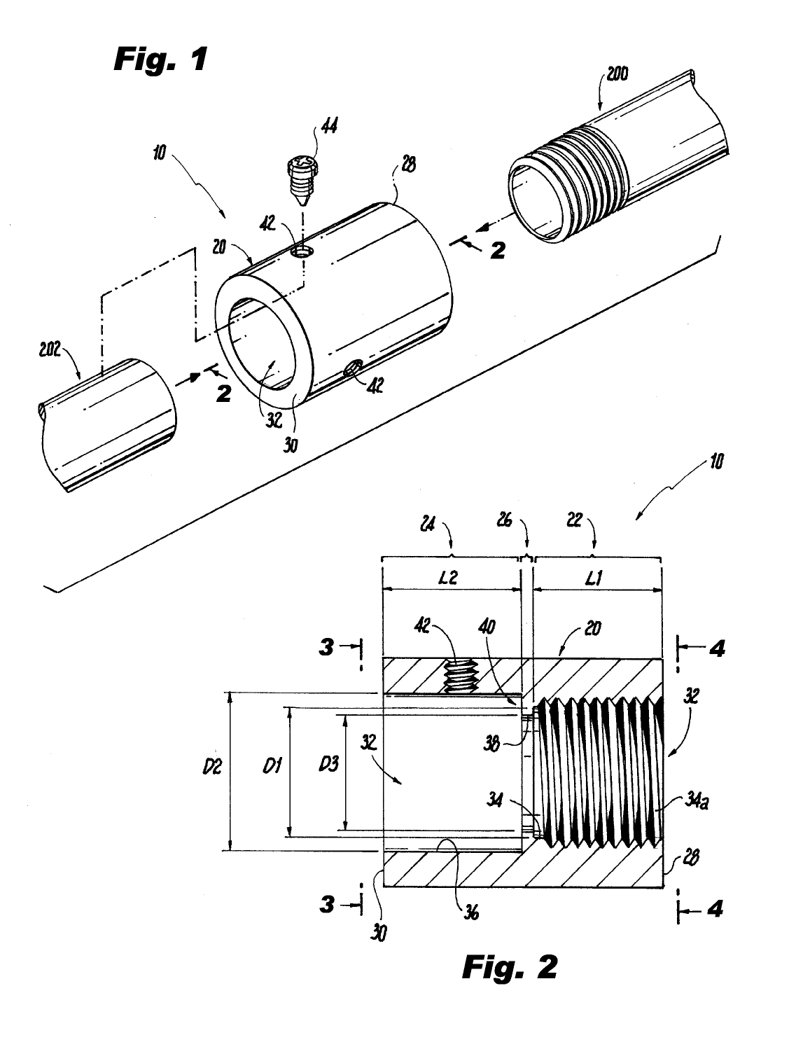

Referring now to FIGS. 1-4, an exemplary embodiment of a coupler according to the present disclosure is shown. The coupler 10 includes a body 20 having a first coupling portion 22, a second coupling portion 24 and a stop portion 26 between the first coupling portion 22 and the second coupling portion 24. The body 20 is generally a tubular member, e.g. a cylindrical tubular member, generally having an interior longitudinal bore 32 extending through the first coupling portion 22, the second coupling portion 24 and the stop portion 26. In the exemplary embodiment shown, the longitudinal bore 32 is configured differently for the first coupling portion 22, the second coupling portion 24 and the stop portion 26, as described in more detail below. In another exemplary embodiment, the longitudinal bore 32 may be uniform between the first coupling portion 22, the second coupling portion 24 and the stop portion 26. The longitudinal bore 32 provides openings to receive threaded or unthreaded conduits, and a wire passage that permits one or more insulated electrical wires, similar to the electrical wire 206 seen in FIG. 6, to pass from one conduit, e.g., threaded conduit 200, coupled to the coupler 10 into another conduit, e.g., unthreaded conduit 202, coupled to the coupler 10.

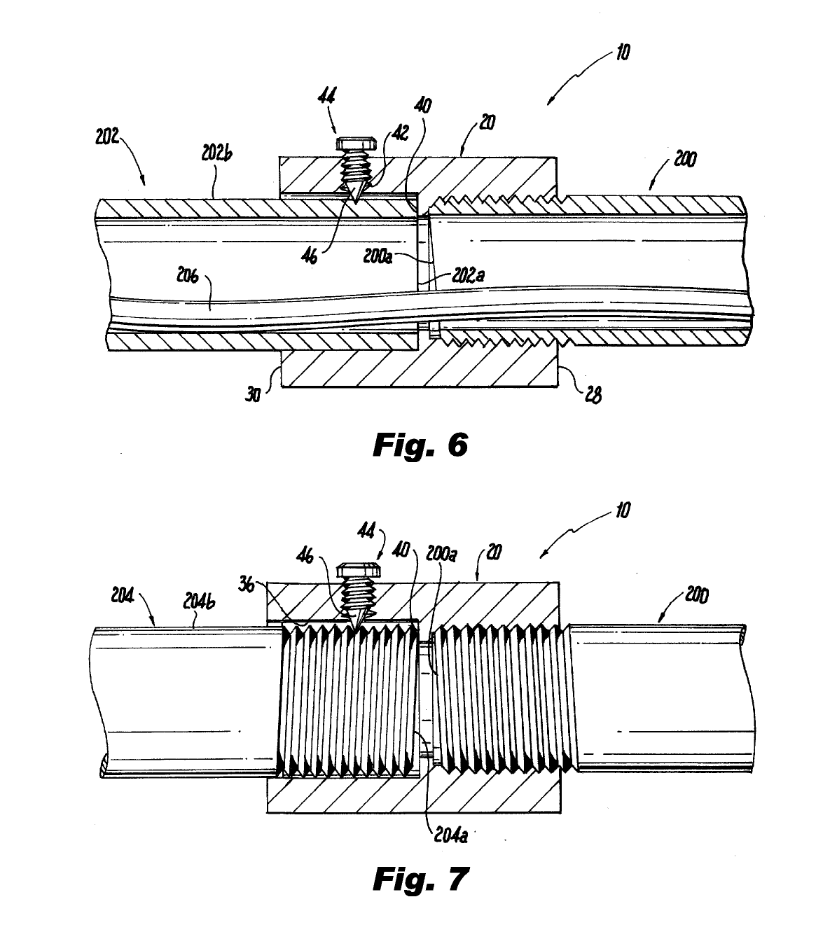

Continuing to refer to FIGS. 1-4, an end 28 of the first coupling portion 22 of the body 20 provides an entrance portal for a threaded conduit 200, seen in FIGS. 1 and 5, to enter the longitudinal bore 32. The portion of the longitudinal bore 32 within the first coupling portion 22 includes an interior wall 34 that is threaded 34a and configured to receive the threaded end of the threaded conduit 200. The diameter “D1” of the interior wall 34 of the longitudinal bore 32 in the first coupling portion 22 is configured to the designated size of the coupler 10. For example, if the coupler 10 is designated as a 1-inch coupler, the diameter “D1” of the interior wall 34 would be sufficient to receive the threaded end of a 1-inch conduit.

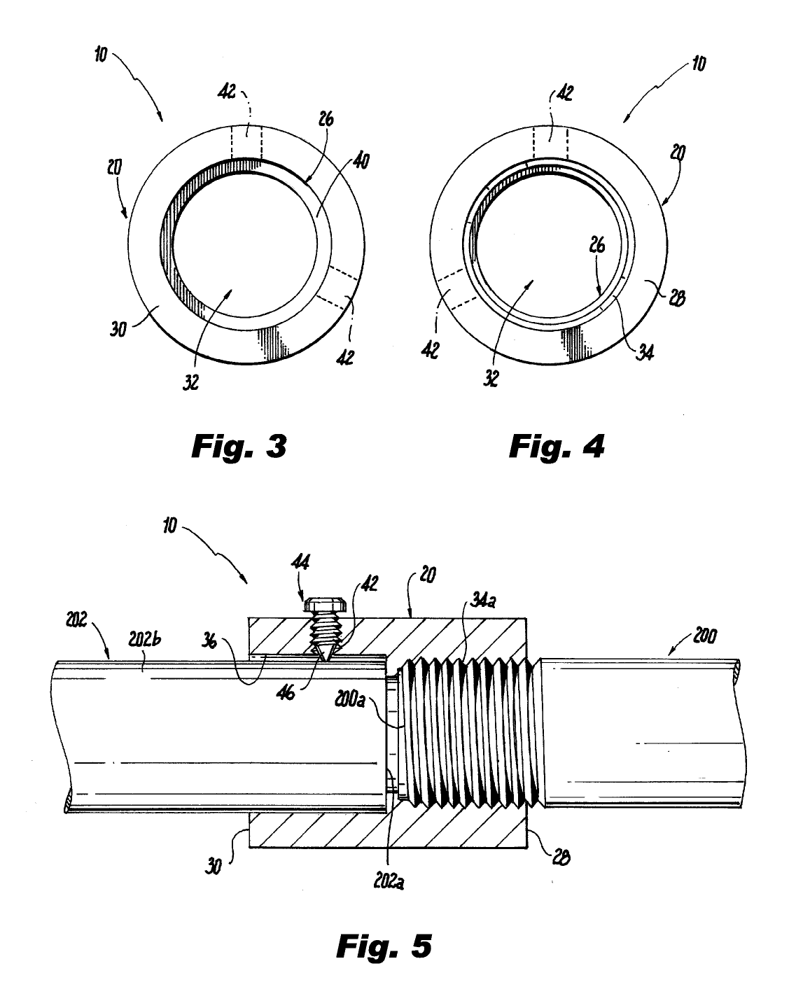

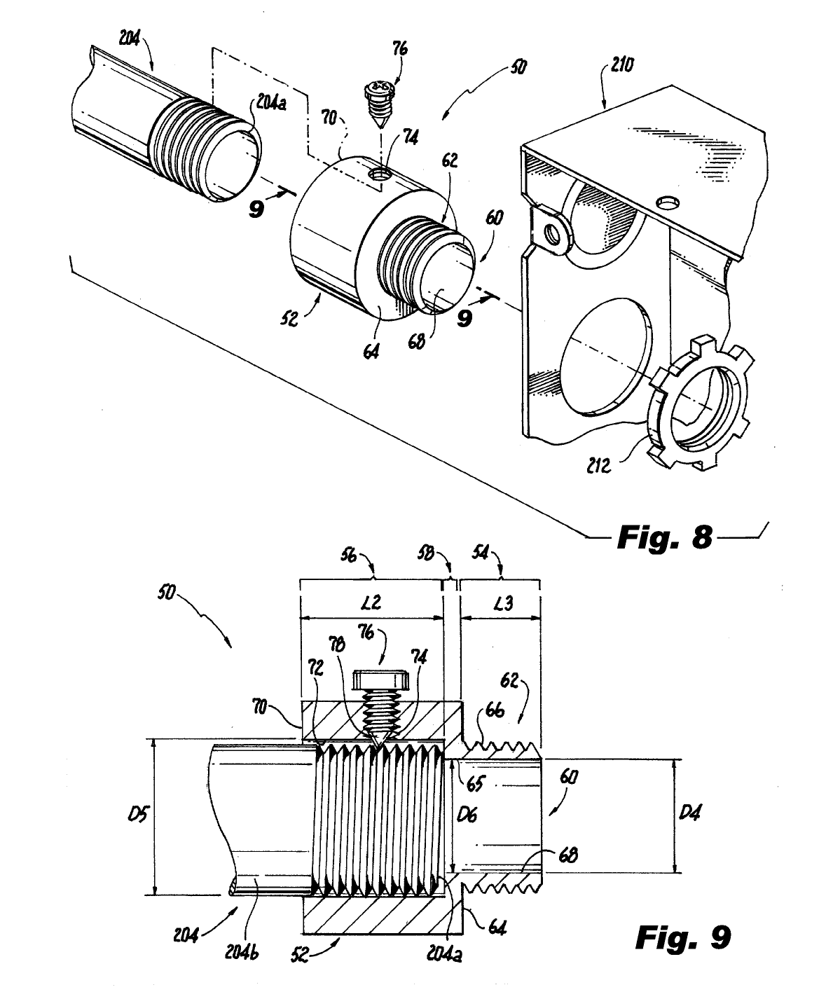

An end 30 of the second coupling portion 24 of the body 20 provides an entrance portal for an unthreaded conduit 202, seen in FIGS. 1 and 5, or a threaded conduit 204, seen in FIGS. 1 and 7, to enter the longitudinal bore 32. The portion of the longitudinal bore 32 within the second coupling portion 24 includes an interior wall 36 that is smooth and configured to receive the unthreaded conduit 202 and the threaded conduit 204. The diameter “D2” of the interior wall 36 of the longitudinal bore 32 in the second coupling portion 24 is configured to receive the designated size of the coupler 10. For example, if the coupler 10 is designated as a 2-inch coupler, the diameter “D2” of the interior wall 36 would be sufficient to receive the unthreaded end and the threaded end of a 2-inch conduit. The second coupling portion 24 of the body 20 includes one or more apertures 42 through the body 20, seen in FIGS. 2 and 3. The one or more apertures 42 through the body 20 may be positioned at various points around the circumference of the body 20 as shown in FIG. 3. The apertures 42 are configured to receive a fastener 44, seen in FIG. 5, that can pass through the body 20 so that a tip 46 of the fastener 44 can enter the longitudinal bore 32 of the second body portion 24 and engage the conduit 202 or 204 within the longitudinal bore 32. The fastener 44 is used to secure the unthreaded end of the unthreaded conduit 202 within the longitudinal bore 32 in the second coupling portion 24 to the body 20. In the event a threaded conduit 204 is inserted into the longitudinal bore 32 in the second coupling portion 24, as seen in FIG. 7, the fastener 44 is used to secure the threaded end of the threaded conduit 204 to the body 20. In the exemplary embodiment shown, the aperture 42 is a threaded aperture and the fastener 44 is a set screw with a pointed tip 46. It is noted that the tip 46 may be a flat tip, a blunt tip, a tapered tip or other shape tip.

Typically, the length “L1” of the first coupling portion 22 is about the same length of the threading at the end of the threaded conduit 200 to be inserted into the first coupling portion 22. For example, if the length of the threading at the end of a 1.0 inch threaded conduit is about 1.0 inch, the length “L1” of the first coupling portion 22 would be about 1.0 inch. In this exemplary embodiment, the length “L2” of the second coupling portion 24 is preferably greater than or equal to the length “L1” of the first coupling portion 22. The length “L2” permits a sufficient length of the unthreaded or threaded conduit to be inserted into the longitudinal bore 32 extending through the second coupling portion 24. Preferably, the length “L2” is sufficient to permit an unthreaded portion of the threaded conduit 204 adjacent the threaded end of the threaded conduit to rest within the longitudinal bore 32, as shown in FIG. 7.

Referring again to FIGS. 2 and 3, the stop portion 26 of the body 20 may be a single member, such as a tab, extending into the longitudinal bore 32. In another embodiment, the stop portion 26 of the body 20 may be a plurality of single members, such as a plurality of tabs, extending into the longitudinal bore 32 and spaced apart around the perimeter of the longitudinal bore. In another embodiment, the stop portion 26 of the body 20 may be a ring or annular ridge extending into the longitudinal bore 32. The tabs or ring may be integrally or monolithically formed into the body 20. In the exemplary embodiment shown in FIG. 3, the stop portion 26 of the body 20 is a ring 40 extending into the longitudinal bore 32. The stop portion 26 is provided to limit the distance the threaded and/or unthreaded conduits may travel within the longitudinal bore 32 as described below. The stop portion 26 also aligns the conduits, e.g., conduits 200 and 202, inserted into the longitudinal bore 32. An inner wall 38 of the stop portion 26, e.g., the inner wall 38 of ring 40, forming the longitudinal bore 32 in the stop portion 26 is greater than or equal to the inside diameter of the threaded conduit 200, and the inside diameter of the unthreaded conduit 202, or the inside diameter of the threaded conduit 204. The inner wall 38 of the longitudinal bore 32 within the stop portion 26 is preferably a smooth wall that permits insulated electrical wires 206, seen in FIG. 6, to pass from one conduit, e.g., conduit 200, to the other conduit, e.g., conduit 202, without negatively impacting the insulating jacket or the electrical wire.

Referring to FIGS. 1, 5 and 6, the coupling of a threaded conduit 200 to an unthreaded conduit 202 will be described. Initially, the open end 28 of the first coupling portion 22 is positioned onto the threaded end of the threaded conduit 200, and the first coupling portion 22 is threaded onto the threaded end of the threaded conduit 200. The threaded conduit 200 is wrench tightened until the end 200a of the threaded conduit 200 contacts the stop portion 26 of the body 20. The unthreaded conduit 202 is inserted through the open end 30 of the second coupling portion 24 into the longitudinal bore 32 until the end 202a of the unthreaded conduit 202 contacts the stop portion 26 of the body 20. Having the end 200a of the threaded conduit 200 and the end 202a of the unthreaded conduit 202 contacting the stop portion 26 ensures full conduit engagement with the coupler 10. The set screw 44 of the second coupling portion 24 is then tightened so that the tip 46 of the set screw 44 engages and possibly cuts into a portion of an outer wall 202b of the unthreaded conduit 202 to secure the unthreaded conduit 202 to the coupler 10. Securing the unthreaded conduit 202 to the coupler 10 also ensures longitudinal alignment between the threaded conduit 200 and the unthreaded conduit 202. As seen in FIG. 6, longitudinal alignment between the threaded conduit 200, the unthreaded conduit 202 and the smooth wall 38 of the stop portion 26 of the body 20 also ensures a smooth transition from threaded conduit 200 to unthreaded conduit 202 so that one or more insulated electrical wires 206 can pass from one conduit to the other conduit without negatively impacting the insulation jacket surrounding the wire.

Referring to FIGS. 1 and 7, the coupling of a threaded conduit 200 to another threaded conduit 204 will be described. Initially, the open end 28 of the first coupling portion 22 is positioned onto the threaded end of the threaded conduit 200, and the first coupling portion 22 is threaded onto the threaded end of the threaded conduit 200. The threaded conduit 200 is wrench tightened until the end 200a of the threaded conduit 200 contacts the stop portion 26 of the body 20. The threaded end of the second threaded conduit 204 is inserted through the open end 30 of the second coupling portion 24 into the longitudinal bore 32 until the end 204a of the threaded conduit 204 contacts the stop portion 26 of the body 20. Having the end 200a of the threaded conduit 200 and the end 204a of the threaded conduit 204 contacting the stop portion 26 ensures full conduit engagement with the coupler 10. The set screw 44 of the second coupling portion 24 is then tightened so that the tip 46 of the set screw 44 engages and possibly cuts into a portion of the threads around the outer wall 204b of the threaded conduit 204 to secure the threaded conduit 204 to the coupler 10. Securing the threaded conduit 204 to the coupler 10 also ensures longitudinal alignment between the threaded conduit 200 and the threaded conduit 204. As described above with reference to FIG. 6, longitudinal alignment between the threaded conduit 200, the threaded conduit 204 and the smooth wall 38 of the stop portion 26, e.g., the wall 38 of ring 40, of the body 20 also ensures smooth transition from threaded conduit 200 to threaded conduit 204 so that one or more insulated electrical wires 206 can pass from one conduit to the other conduit without negatively impacting the insulation jacket surrounding the wire.

Referring now to FIGS. 8 and 9, another exemplary embodiment of a coupler according to the present disclosure is shown. In this exemplary embodiment, the coupler 50 includes a body 52 having a first coupling portion 54, a second coupling portion 56 and a stop portion 58 between the first coupling portion 54 and the second coupling portion 56. The body 52 is generally a tubular member, e.g. a cylindrical tubular member, generally having an interior longitudinal bore 60 extending through the first coupling portion 54, the second coupling portion 56 and the stop portion 58. In the exemplary embodiment shown, the longitudinal bore 60 is configured differently for the first coupling portion 54, the second coupling portion 56 and the stop portion 58, as described in more detail below. In another exemplary embodiment, the longitudinal bore 60 may be uniform between the first coupling portion 54, the second coupling portion 56 and the stop portion 58. The longitudinal bore 60 provides openings to receive threaded or unthreaded conduits and a wire passage. The wire passage permits one or more insulated electrical wires, similar to the electrical wire 206 seen in FIG. 6, to pass from a conduit, e.g., threaded conduit 204, coupled to the coupler 50 into and electrical box or an electrical fitting coupled to the coupler 50. Non-limiting examples of such electrical fittings include rigid LB or T type threaded conduit bodies, adapters and couplers.

In this exemplary embodiment, the first coupling portion 54 includes a nipple 62 extending from an end wall 64 of the stop portion 58. The nipple 62 includes threads along an outer wall 66 configured to receive a locking nut 212, seen in FIG. 8 or a threaded end of an electrical fitting. The portion of the longitudinal bore 60 within the first coupling portion 54 includes an interior wall 68 that is smooth. The diameter “D4” of the interior wall 68 of the longitudinal bore 60 within the first coupling portion 54 is configured to the designated size of the coupler 50 so that there is a substantially smooth transition from the interior wall 68 of the longitudinal bore 60 within the first coupling portion 54 to the interior of the conduit 204 or 202 within the second coupling portion 56. For example, if the coupler 50 is designated as a 1-inch coupler, the diameter “D4” of the interior wall 68 would be about the same as the diameter of an interior wall of a 1-inch conduit.

Continuing to refer to FIGS. 8 and 9, an end 70 of the second coupling portion 56 of the body 50 provides an entrance portal for a threaded conduit 204, seen in FIG. 9, or an unthreaded conduit 202, seen in FIG. 5, to enter the longitudinal bore 60. The portion of the longitudinal bore 60 within the second coupling portion 56 includes an interior wall 72 that is smooth and configured to receive the threaded conduit 204 or the unthreaded conduit 202. The diameter “D5” of the interior wall 72 of the longitudinal bore 60 in the second coupling portion 56 is configured to receive conduits of the designated size of the coupler 50. For example, if the coupler 50 is designated as a 1-inch coupler, the diameter “D5” of the interior wall 72 would be sufficient to receive the threaded end and the unthreaded end of a 1-inch conduit. The second coupling portion 56 of the body 52 includes one or more apertures 74 through the body 52. The one or more apertures 74 through the body 52 may be positioned at various points around the circumference of the body 52, similar to the apertures 42 shown in FIG. 3. The apertures 74 are configured to receive a fastener 76 that can pass through the body 52 so that a tip 78 of the fastener 76 can enter the longitudinal bore 60 of the second coupling portion 56 and engage the conduit 204 or 202 within the longitudinal bore 60 of the second coupling portion 56. The fastener 76 is used to secure the threaded end of the threaded conduit 204 within the longitudinal bore 60 within the second coupling portion 56 to the body 52. In the event an unthreaded conduit 202 is inserted into the longitudinal bore 60, the fastener 76 is used to secure the unthreaded end of the unthreaded conduit 202 within the longitudinal bore 60 of the second coupling portion 56 to the body 52. In the exemplary embodiment shown, the aperture 74 is a threaded aperture and the fastener 76 is a set screw with a pointed tip 78. It is noted that the tip 78 may be a flat tip, a blunt tip, a tapered tip or other shape tip.

Typically, the length “L3” of the first coupling portion 54 is sufficient to extend into an electrical box or is about the same length of as the threading of the electrical fitting to be threaded onto the nipple 62. For example, a typical length “L3” of the first coupling portion 22 to extend into an electric box is about 0.5 inch. The length “L2” of the second coupling portion 56 is preferably greater than or equal to the length “L3” of the first coupling portion 54. The length “L2” permits a sufficient length of the unthreaded or threaded conduit to be inserted into the longitudinal bore 60 extending through the second coupling portion 56.

Continuing to refer to FIGS. 8 and 9, the stop portion 58 of the body 52 may be a ring or annular ridge that is integrally or monolithically formed into the second coupling portion 56. In the exemplary embodiment shown, the stop portion 58 of the body 52 is a ring forming an end wall 64 of the stop portion 58. The stop portion 58 is provided to limit the distance the coupler 50 may extend into an electrical box 210 or the distance the coupler 50 may extend into an electrical fitting. The stop portion 58 is also provided to limit the distance the threaded and/or unthreaded conduits may travel within the longitudinal bore 60 of the second coupling portion 56. The stop portion 58 aligns the conduit, e.g., conduit 202 or 204, inserted into the longitudinal bore 60 of the second coupling portion 56 with the interior wall 68 of the nipple 62. An inner wall 65 of the stop portion 58 forming the longitudinal bore 60 in the stop portion 58 has a diameter “D6” that may be equal to or greater than the inside diameter “D4” of the nipple 62. The diameter “D6” of the inner wall 65 may also be equal to or greater than in inside diameter of the threaded conduit 204. In the event the conduit inserted into the longitudinal bore 60 of the second coupling portion 56 is an unthreaded conduit 202, seen for example in FIG. 5, the inner wall 65 preferably has a diameter “D6” that may be equal to or greater than the inside diameter of the unthreaded conduit 204. The inner wall 65 of the longitudinal bore 60 within the stop portion 58 is preferably a smooth wall that permits insulated electrical wires 206 to pass from the conduit, e.g., conduit 204 or 202, into the electrical box 210 or an electrical fitting without negatively impacting the insulating jacket or the electrical wire.

The coupling of a threaded conduit 204 to an electrical box 210 will be described with reference to FIGS. 8 and 9. Initially, the nipple 62 forming the first coupling portion 54 of the coupler 50 is inserted into an opening, e.g., a knockout, in the electrical box 210 and secured to the electrical box using a locking nut 212 so that the stop portion 58 of the coupler 50 engages the wall of the electrical box. A threaded conduit 204 is inserted through the open end 70 of the second coupling portion 56 into the longitudinal bore 60 until the end 204a of the threaded conduit 204 contacts the stop portion 58 of the body 52, as shown. Having the end 204a of the threaded conduit 204 contacting the stop portion 58 ensures full conduit engagement with the coupler 50. The set screw 76 of the second coupling portion 56 is then tightened so that the tip 78 of the set screw 76 engages and possibly cuts into the threads on a portion of an outer wall 204b of the threaded conduit 204 to secure the threaded conduit 204 to the coupler 50. Securing the threaded conduit 204 to the coupler 50 also ensures longitudinal alignment between the threaded conduit 204, the longitudinal bore 60 in the stop portion 58 and the longitudinal bore 60 in the first coupling portion 54. As seen in FIG. 9, longitudinal alignment between the threaded conduit 204, the smooth wall 65 of the stop portion 58 and the smooth wall 68 of the first coupling portion 54 also ensures a smooth transition from the threaded conduit 204 to the electrical box 210 so that one or more insulated electrical wires 206 can pass from the threaded conduit into the electrical box or an electrical fitting without negatively impacting the insulation jacket surrounding the wire. It is noted that a similar process may be used to couple an unthreaded conduit 202 to an electrical box.

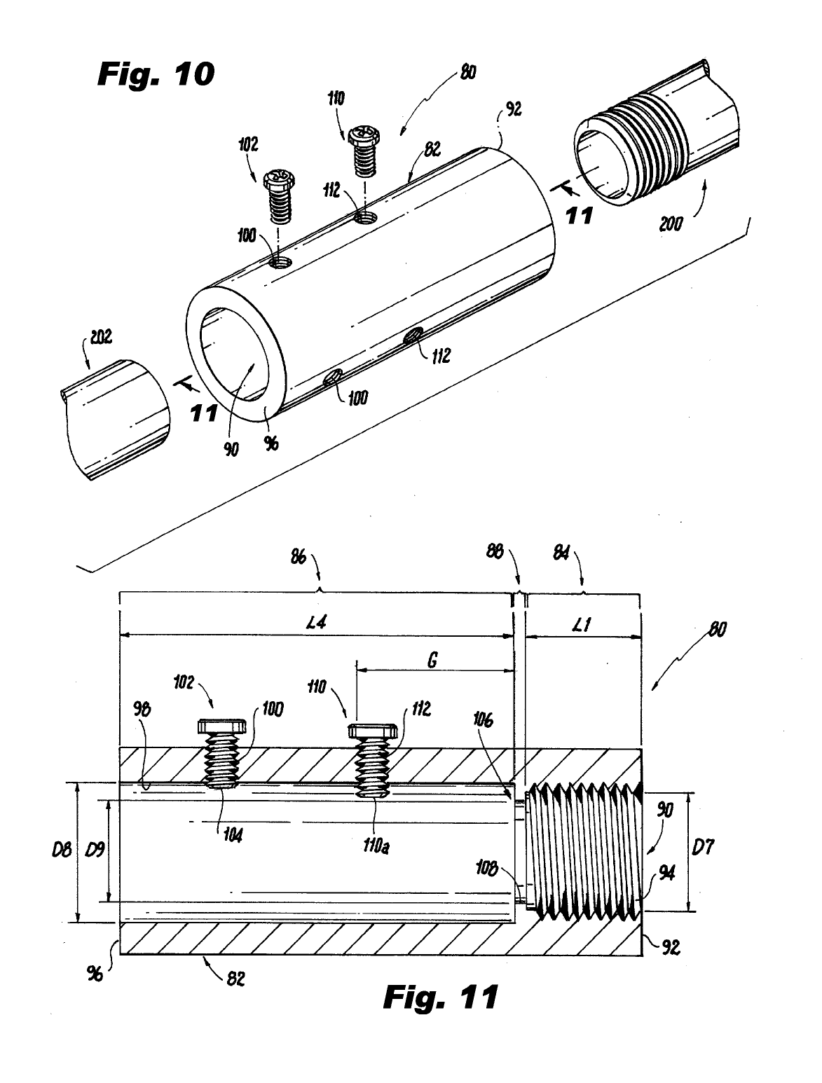

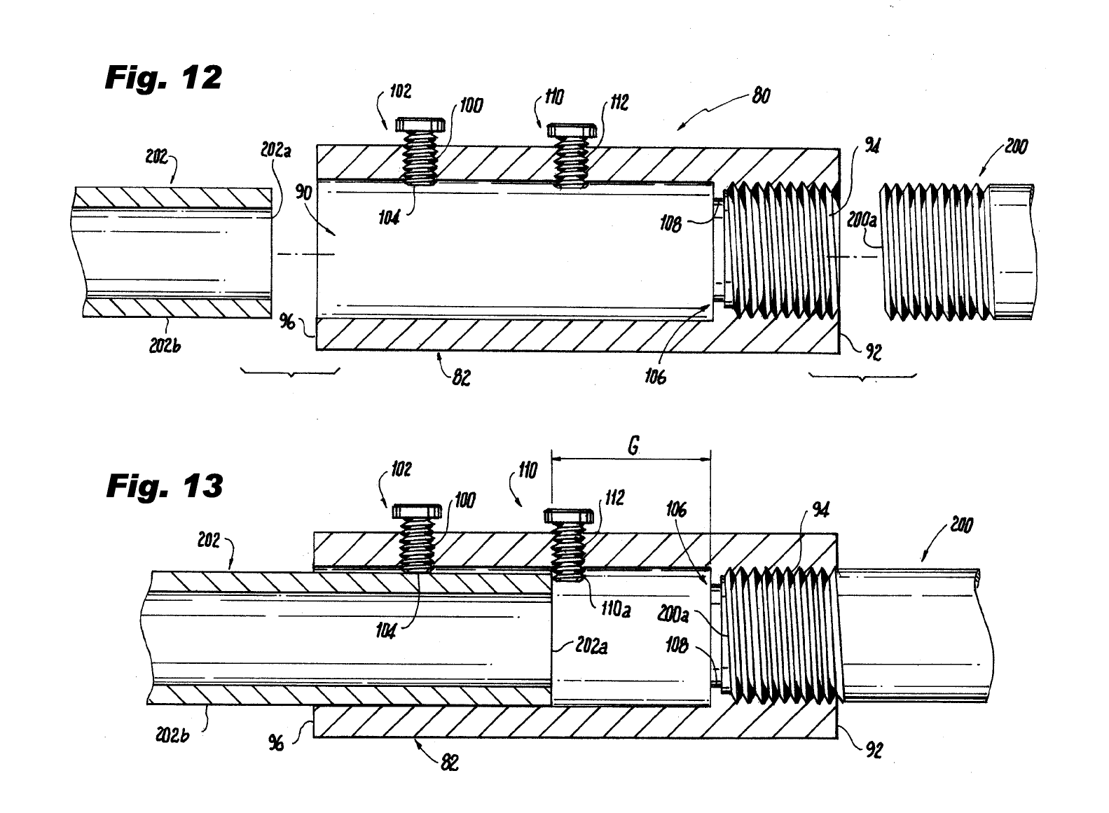

Referring now to FIGS. 10 and 11, another exemplary embodiment of a coupler according to the present disclosure is shown. In this exemplary embodiment, the coupler 80 includes a body 82 having a first coupling portion 84, a second coupling portion 86 and a stop portion 88 between the first coupling portion 84 and the second coupling portion 86. The body 82 is a tubular member. e.g. a cylindrical tubular member, generally having an interior longitudinal bore 90 extending through the first coupling portion 84, the second coupling portion 86 and the stop portion 88. The longitudinal bore 90 may be configured differently for the first coupling portion 84, the second coupling portion 86 and the stop portion 88 as described below. In another exemplary embodiment, the longitudinal bore 90 may be uniform between the first coupling portion 84, the second coupling portion 86 and the stop portion 88. The longitudinal bore 90 provides a wire passage through the coupler 80 that permits one or more insulated electrical wires, similar to the electrical wire 206 seen in FIG. 6, to pass from one conduit, e.g., threaded conduit 200, seen in FIG. 12, coupled to the coupler 80 into another conduit, e.g., unthreaded conduit 202, coupled to the coupler.

Referring to FIGS. 10-12, an end 92 of the first coupling portion 84 of the body 82 provides an entrance portal for a threaded conduit 200 to enter the longitudinal bore 90. The portion of the longitudinal bore 90 within the first coupling portion 84 includes an interior wall 94 that is threaded and configured to receive the threaded end of the threaded conduit 200. The diameter “D7” of the interior wall 94 of the longitudinal bore 90 in the first coupling portion 84 is configured to the designated size of the coupler 80. For example, if the coupler 80 is designated as a 1.0 inch coupler, the diameter “D7” of the interior wall 94 would be sufficient to receive the threaded end of a 1.0 inch conduit.

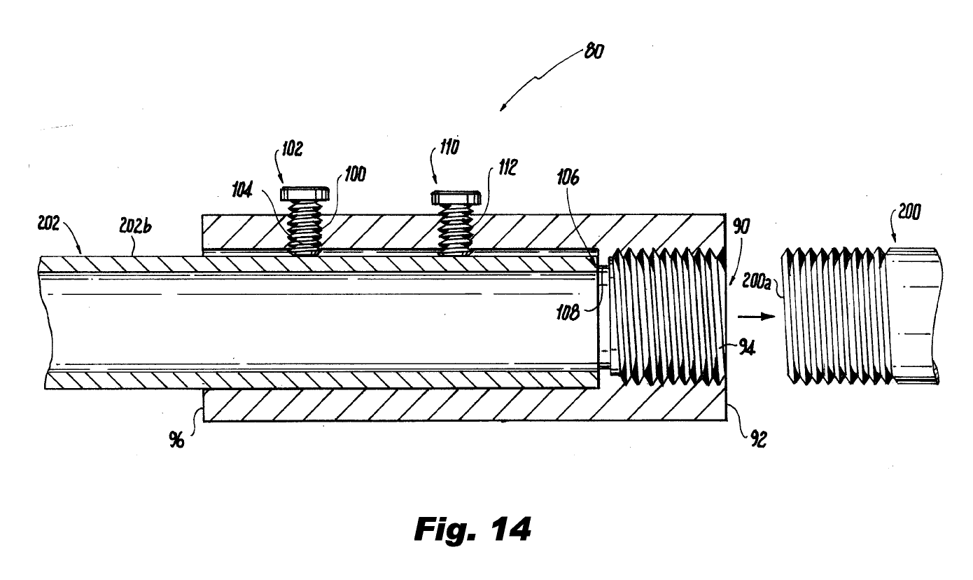

An end 96 of the second coupling portion 86 of the body 82 provides an entrance portal for an unthreaded conduit 202, seen in FIGS. 12 and 13, or a threaded conduit 204, seen in FIG. 7, to enter the longitudinal bore 90 within the second coupling portion 86. The portion of the longitudinal bore 90 within the second coupling portion 86 includes an interior wall 98 that is smooth and configured to receive the unthreaded conduit 202 and the threaded conduit 204. The diameter “D8” of the interior wall 98 of the longitudinal bore 90 in the second coupling portion 86 is configured to receive conduit matching the designated size of the coupler 80. For example, if the coupler 80 is a 1.0 inch coupler, the diameter “D8” of the interior wall 98 would be sufficient to receive both the unthreaded end and threaded end of a 1.0 inch conduit. The second coupling portion 86 of the body 82 includes one or more apertures 100 through the body 82 of the second coupling portion 86, seen in FIGS. 10 and 11. The one or more apertures 100 through the body 82 may be positioned at various points around the circumference of the body 82 similar to apertures 42 shown in FIG. 3. The apertures 100 are configured to receive a fastener 102 that can pass through the body 82 so that a tip 102 of the fastener 102 can enter the longitudinal bore 90 of the second body portion 86 and engage the conduit 202 or 204 within the longitudinal bore 90. The fastener 102 is used to secure the unthreaded end of the unthreaded conduit 202 within the longitudinal bore 90 in the second coupling portion 86 to the body 82. In the event a threaded conduit 204 is inserted into the longitudinal bore 90 within the second coupling portion 86, the fastener 102 is used to secure the threaded end of the threaded conduit 204 within the longitudinal bore 90 of the second coupling portion 86 to the body 82. In the exemplary embodiment shown, the one or more apertures 100 are threaded apertures and the fastener 102 is a set screw with a flat tip 104. However, the tip 104 may be a blunt tip, a tapered tip, a pointed tip, similar to the pointed tip 46 of the fastener 44 shown in FIG. 5, or other shaped tips.

Typically, the length “L1” of the first coupling portion 84 is about the same length of the threading at the end of the conduit 200 to be inserted into the first coupling portion 84. For example, if the length of the threading at the end of a 1.0 inch threaded conduit is about 1.0 inch, the length “L1” of the first coupling portion 84 would be about 1.0 inch. The length “L4” of the second coupling portion 86 is preferably greater than the length “L1” of the first coupling portion 84 by at least two-times the length “L1”. The length “LA” permits a sufficient length of the unthreaded or threaded conduit to be inserted into the portion of the longitudinal bore 90 within the second coupling portion 86, and leaves a gap “G” that permits movement of the conduit 202 or 204 when removing the coupler from the conduits, as described in more detail below.

Continuing to refer to FIGS. 10 and 11, the stop portion 88 of the body 82 may be a single member, such as a tab, extending into the longitudinal bore 90. In another embodiment, the stop portion 88 of the body 82 may be a plurality of single members, such as a plurality of tabs, extending into the longitudinal bore 90 and spaced apart around the perimeter of the longitudinal bore. In another embodiment, the stop portion 88 of the body 82 may be a ring or annular ridge 106 extending into the longitudinal bore 90. The tabs or ring may be integrally or monolithically formed into the body 82. In the exemplary embodiment shown, the stop portion 88 of the body 82 is a ring 106 extending into the longitudinal bore 90, which is similar to the ring 40 described above. The stop portion 88 is provided to limit the distance the threaded and/or unthreaded conduits may travel within the longitudinal bore 90 as described below. An inner wall 108 of the stop portion 88 forming the portion of the longitudinal bore 90 within in the stop portion 88 has a diameter “D9” that may be greater than or equal to the inside diameter of the threaded conduit 200, and the inside diameter of the unthreaded conduit 202 or the inside diameter of the threaded conduit 204. The inner wall 108 of the longitudinal bore 90 within the stop portion 88 is preferably a smooth wall that permits insulated electrical wires to pass from one conduit, e.g., conduit 204 or 202, through the stop portion 88 into the other conduit, e.g., conduit 200, without negatively impacting the insulation jacket surrounding the electrical wire.

Continuing to refer to FIGS. 10 and 11, the coupler 80 also includes a second stop member 110 that is a removable stop member. More specifically, the second coupling portion 86 of the body 82 includes one or more stop mounting apertures 112 through the body 82. The one or more stop apertures 112 through the body 82 may be positioned at various points around the circumference of the body 82. The one or more stop mounting apertures 112 are configured to receive the second stop member 110 so that the second stop member can pass through the body 82 and enter the longitudinal bore 90 of the second body portion 86. The one or more stop mounting apertures 112 are positioned on second coupling portion 86 of the body 82 so that the gap “G” can be formed between the second stop member 110 and the stop portion 88. The gap “G” is preferably equal to or greater than the length “L1” of the first coupling portion 84. Forming a gap between the between the second stop member 110 and the stop portion 88 permits the removal of the coupling 80 from the conduit 200 without the need to cut the conduit, as described in more detail below.

Referring now to FIGS. 10-13, the coupling of a threaded conduit 200 to an unthreaded conduit 202 will be described. Initially, the open end 92 of the first coupling portion 84 is positioned onto the threaded end of the threaded conduit 200, seen in FIG. 12, and the first coupling portion 84 is threaded onto the threaded end of the threaded conduit 200, as shown in FIG. 13. The threaded conduit 200 is wrench tightened until the end 200a of the threaded conduit 200 contacts the stop portion 88 of the body 82. The stop member 110 is then inserted, e.g., threaded, into the stop mounting aperture 112 so that the distal end 110a of the stop member 110 is within the longitudinal bore 90 of the second coupling portion 86, seen in FIGS. 11 and 13. The unthreaded conduit 202 is inserted through the open end 96 of the second coupling portion 86 into the longitudinal bore 90 until the end 202a of the unthreaded conduit 202 contacts at least the distal end 110a of the stop member 110, seen in FIG. 13. When the distal end 110a of the stop member 110 is in a position to contact the end 202a of the unthreaded conduit 202, the stop member 110 is in an engaging position. When the distal end 110a of the stop member 110 is not in a position to contact the end 202a of the unthreaded conduit 202, the stop member 110 is in a non-engaging position. The set screw 102 of the second coupling portion 86 is then tightened so that the tip 104 of the set screw 102 engages and possibly cuts into a portion of an outer wall 202b of the unthreaded conduit 202 to secure the unthreaded conduit 202 to the coupler 80.

To remove the threaded conduit 200 from the coupler 80, the second stop member 110 is withdrawn, e.g., unscrewed, from the stop mounting aperture 112 so that the distal end 110a of the second stop member 110 is no longer within the longitudinal bore 90 of the second coupling portion 86. The threaded conduit 200 is then removed, e.g., unscrewed, from the first coupling portion 84. As the threaded conduit 200 is being removed from the coupler 80, the unthreaded end of the unthreaded conduit 202 begins to fill the gap “G,” as seen in FIG. 14, so that there is sufficient room for the threaded conduit 200 to separate from the first coupling portion 84. It is noted that coupling and decoupling a threaded conduit 200 to and from another threaded conduit 204 using the coupler 80 is the same as described above with an unthreaded conduit 202.

The couplers according to the present disclosure are capable of coupling two threaded conduits, or a threaded conduit with an unthreaded conduit with a minimum number of parts, which reduces the cost to fabricate the coupler and which reduces the time to install the coupler. The couplers according to the present disclosure provide a smooth transition of insulated electrical conductors from one conduit to another conduit in compliance with product listing agencies, such as Underwriters Laboratories (UL), and in accordance with the National Electrical Code (NEC).

Although a preferred embodiment has been disclosed herein, it is to be remembered that various modifications and alternate construction can be made thereto without departing from the full scope of the invention, as defined in the appended claims.

What is claim is:

1. An electrical conduit coupler, comprising a body having a first coupling portion, a second coupling portion, a stop portion positioned between the first coupling portion and the second coupling portion, and a longitudinal bore extending from the first coupling portion through the stop portion to the second coupling portion, wherein the longitudinal bore within the first coupling portion is a threaded bore capable of receiving a threaded end of a first threaded electrical conduit, wherein the longitudinal bore within the second coupling portion has a diameter capable of receiving a threaded end of a second threaded conduit or an unthreaded end of an unthreaded conduit, and wherein the longitudinal bore within the stop portion has a diameter that provides a wire passage between the first threaded conduit and the second threaded conduit or the unthreaded conduit.

2. The electrical conduit coupler according to claim 1, wherein the second coupling portion includes at least one aperture, and at least one fastener within the at least one aperture used to releasably secure the second threaded conduit or the unthreaded conduit to the body.

3. The electrical conduit coupler according to claim 1, wherein the second coupling portion of the body includes a plurality of spaced apart apertures and a plurality of fasteners wherein one of the plurality of fasteners is within one of the plurality of apertures, and wherein the plurality of fasteners are used to releasably secure the second threaded conduit or the unthreaded conduit to the body.

4. The electrical conduit coupler according to claim 1, wherein the stop portion comprises a ring integrally or monolithically formed into the body.

5. The electrical conduit coupler according to claim 1, wherein a length of the second coupling portion is greater than or equal to a length of the first coupling portion.

6. The electrical conduit coupler according to claim 1, wherein the longitudinal bore within the second coupling portion has a smooth wall.

7. The electrical conduit coupler according to claim 1, wherein the first coupling portion comprises a female coupling portion and the second coupling portion comprises a female coupling portion.

8. An electrical conduit coupler, comprising a body having a first coupling portion, a second coupling portion, a stop portion positioned between the first coupling portion and the second coupling portion, and a longitudinal bore extending from the first coupling portion through the stop portion to the second coupling portion;
wherein a length of the second coupling portion is at least twice a length of the first coupling portion;
wherein the longitudinal bore within the first coupling portion is a threaded bore capable of receiving a threaded end of a first threaded electrical conduit, wherein the longitudinal bore within the second coupling portion has a diameter capable of receiving a threaded end of a second threaded conduit or an unthreaded end of an unthreaded conduit, and wherein the longitudinal bore within the stop portion has a diameter that provides a wire passage between the first threaded conduit and the second threaded conduit or the unthreaded conduit; and
wherein the second coupling portion of the body includes at least one stop mounting aperture and at least one stop member within the stop mounting aperture, the at least one stop member being movable within the stop mounting aperture between an engaging position and a non-engaging position.

9. The electrical conduit coupler according to claim 8, wherein the second coupling portion of the body includes at least one aperture, and at least one fastener within the at least one aperture and used to releasably secure the second threaded conduit or the unthreaded conduit to the body.

10. The electrical conduit coupler according to claim 8, wherein the second coupling portion of the body includes a plurality of spaced apart apertures and a plurality of fasteners, wherein one of the plurality of fasteners is within one of the plurality of apertures, and wherein the plurality of fasteners are used to releasably secure the second threaded conduit or the unthreaded conduit to the body.

11. The electrical conduit coupler according to claim 8, wherein the stop portion comprises a ring integrally or monolithically formed into the body.

12. The electrical conduit coupler according to claim 8, wherein the longitudinal bore within the second coupling portion has a smooth wall.

13. The electrical conduit coupler according to claim 8, wherein the first coupling portion comprises a female coupling portion and the second coupling portion comprises a female coupling portion.

14. An electrical conduit coupler, comprising a body having a male coupling portion, a female coupling portion, a stop portion positioned between the male coupling portion and the female coupling portion, and a longitudinal bore extending from the male coupling portion through the stop portion to the female coupling portion, wherein the longitudinal bore within the male coupling portion is a threaded bore capable of receiving a threaded end of a first threaded electrical conduit, wherein the longitudinal bore within the female coupling portion has a diameter capable of receiving a threaded end of a second threaded conduit or an unthreaded end of an unthreaded conduit, and wherein the longitudinal bore within the stop portion has a diameter that provides a wire passage between the first threaded conduit and the second threaded conduit or the unthreaded conduit.

15. The electrical conduit coupler according to claim 14, wherein the female coupling portion of the body includes at least one aperture, and at least one fastener within the at least one aperture used to releasably secure the second threaded conduit or the unthreaded conduit to the body.

16. The electrical conduit coupler according to claim 14, wherein the female coupling portion of the body includes a plurality of spaced apart apertures and a plurality of fasteners, wherein one of the plurality of fasteners is within one of the plurality of apertures, and wherein the plurality of fasteners are used to releasably secure the second threaded conduit or the unthreaded conduit to the body.

17. The electrical conduit coupler according to claim 14, wherein the male coupling portion comprises a threaded nipple.

18. The electrical conduit coupler according to claim 14, wherein a length of the female coupling portion is greater than or equal to a length of the male coupling portion.

19. The electrical conduit coupler according to claim 14, wherein the longitudinal bore within the female coupling portion has a smooth wall.
